(19) United States
(12) Patent Application Publication
(10) Pub. No.: US 2010/0122410 A1
(43) Pub. Date: May 20, 2010

(54) PORTABLE DEVICE FOR CLEANING AND MASSAGING THE SKIN

(76) Inventor: Hervè Gourdin, Cucuron (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/720,769

(22) PCT Filed: Dec. 9, 2005
(86) PCT No.: PCT/FR05/03098

§ 371 Date: Sep. 20, 2007

(30) Foreign Application Priority Data
Dec. 9, 2004 (FR) 04 13142

(51) Int. Cl. A47K 3/00; A61H 9/00

(52) U.S. Cl. 4/618; 601/166; 4/615

(57) ABSTRACT

The invention concerns a portable device (10) for cleaning and massaging the skin, comprising means (18, 22) for being fixed on a person's body part, means (26) for being connected to fluid supply means (28), and means (20, 30, 32) for circulating fluid connected to the connecting means (26) and designed to extend around and/or along the person's body part, said circulating means (20, 30, 32) comprising orifices (34, 36) or nozzles (38) for spraying fluid on said person's body part.

The present invention relates to a portable device that is usable, in particular, for cleansing, massaging, and relaxing the skin of a portion of a person's body, in particular the that person's face.

### BACKGROUND OF THE INVENTION

Skin cleansing and massaging devices are known that include spray means for spraying a cleansing liquid onto a portion of a person's body, which spray means are carried by fixed means disposed on or next to the person, or by means that can be manipulated by hand. The spray means are connected to water feed means via a pump that serves to increase the pressure of the water delivered by the spray means.

Such devices are used exclusively by healthcare professionals or by specialized institutes because they are voluminous and costly, and require an energy source to be used.

### OBJECTS AND SUMMARY OF THE INVENTION

An object of the invention is to provide a device for cleansing and massaging skin that does not suffer from those drawbacks, that is simple to use, and that is inexpensive.

To this end, the invention provides a portable device for cleansing and massaging the skin, said device comprising fastener means for fastening to a portion of a person's body, connection means for connecting to fluid feed means such as a water supply network, and fluid carrier means connected to the connection means and designed to extend around and/or along a portion of the person's body, at a short distance therefrom, said fluid carrier means being provided with orifices and/or with nozzles for spraying fluid onto said portion of the person's body.

The fluid used may be water in vapor or liquid form, or a liquid or a gas suitable for treating the skin.

The device of the invention is portable and can be used either by a healthcare professional or by a private individual, at home or away from home.

The fluid used is advantageously liquid water, the device being fastened to that portion of the person's body that is to be cleansed and massaged, and being connected directly to the water supply network. In which case, it does not include a pump, and operates without being connected to an electrical or other energy source.

Optionally, and in particular for professional use, said device can be connected to a pump in order to increase the pressure of the fluid delivered by the spray means.

The device of the invention makes it possible to massage and to relax the skin and the underlying tissue, and to improve the vascularization of the corresponding portion of the body.

In simple manner, the connection means comprise a housing provided with a first water-passing channel that opens out freely at the end of the housing, with a second water-passing channel for water that feeds the device, and with selector means for opening the first channel and closing the second channel or vice versa.

The connection means are advantageously connected to the shower hose receiving orifice provided on a shower or bath mixer faucet, the shower hose then being connected to the outlet of the first water-passing channel of the housing. Opening the first channel makes it possible to use the shower, and opening the second channel makes it possible to use the device of the invention.

The connection means preferably comprise ingredient-receiving means for receiving at least one active ingredient packaged in a capsule, tablet, pellet, or the like for the purpose of releasing said active ingredient in controlled manner into the fluid flowing through the first channel or through the second channel.

The active ingredient may also be in the form of a liquid, of a gel, of a bead, of a capsule, of a tablet, of a pellet, or of the like, and has an invigorating, reparative, relaxing, or soothing property for the skin. For example, it is possible to use essential oils, plant extracts, surfactants, medicinal substances, etc., or mixtures thereof.

Advantageously, the active ingredient is packaged in a cartridge or in a small bottle that is mounted in a compartment provided in the above-mentioned housing and designed for receiving the cartridge or the bottle, which compartment is provided with means for automatically opening the cartridge or the bottle, and with means for releasing the active ingredient in controlled manner when the water is flowing.

The device is usable in a medical, beauty, or cosmetology context, and takes part in dermatological treatment such as, for example, treatment of acne or removal or reduction of scars or of wrinkles.

The fluid carrier means are of adjustable length, e.g. telescopic, are deformable, and/or are hinged so as to match the shapes of the portion of the person's body, a short distance away therefrom.

The device of the invention thus adapts to the shapes of the person and can thus be made in one-size only.

The fluid carrier means comprise at least one duct equipped with fluid spray means over at least a portion of its length, the fluid spray means comprising, for example, fixed and/or rotary nozzles for spraying fluid in a sweeping motion.

In an embodiment of the invention, the device is designed to be fastened to a person's head and includes eye-protection goggles whose side branches form fluid carrier ducts.

Other fluid carrier ducts equipped with fluid spray means and connected to the side branches of the goggles are designed to spray fluid onto the chin, the nose, the cheeks, the temples, the forehead, the cranium, and/or the neck of the person.

### BRIEF DESCRIPTION OF THE DRAWINGS

Other characteristics and advantages of the invention appear on reading the following description given by way of non-limiting example and with reference to the accompanying drawings, in which:

FIG. 1 is a diagrammatic perspective view of an embodiment of the device of the invention;

FIG. 2 is a diagrammatic perspective view of a variant embodiment of the device;

FIGS. 3 to 7 diagrammatically show water carrier ducts equipped with spray means for spraying water;

FIGS. 8 and 9 are diagrammatic section views of the connection means of the device of the invention, respectively showing how the second water-passing channel opens, and how the first water-passing channel opens; and

FIG. 10 is a diagrammatic section view of a variant embodiment of the connection means.

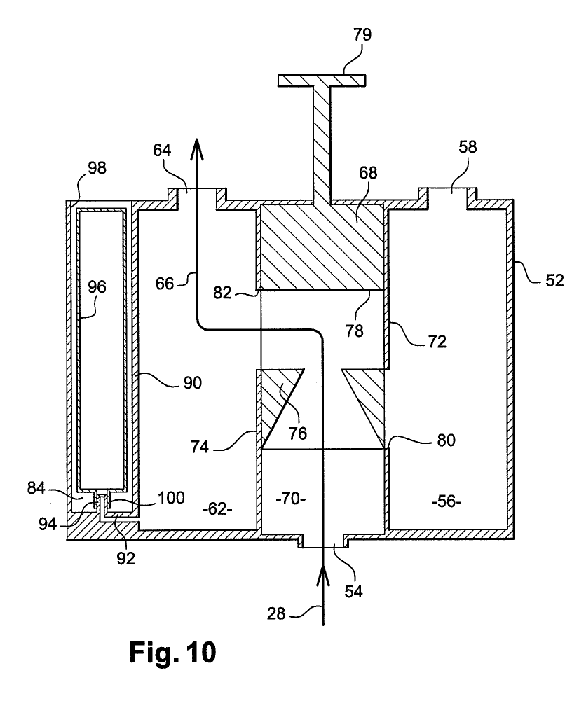

### MORE DETAILED DESCRIPTION

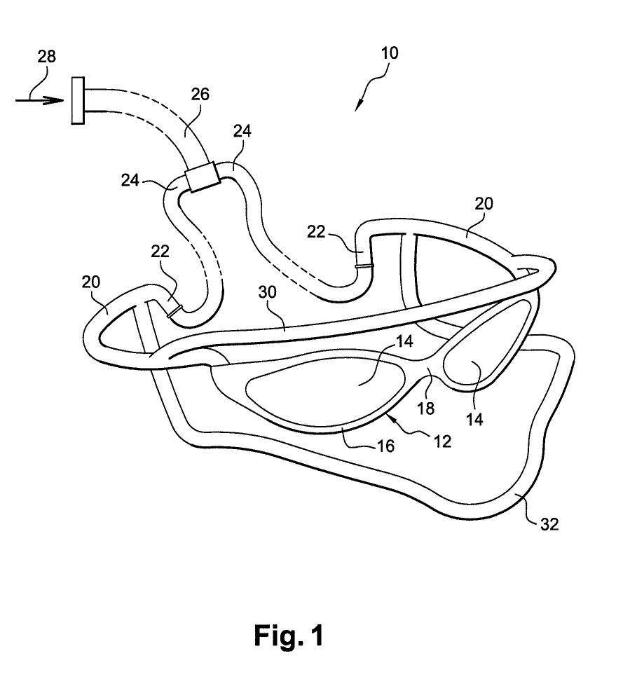

The device 10 of the invention shown in FIG. 1 makes it possible, in particular, to cleanse and to massage a person's face by spraying water onto said face. It is designed to be fastened to the person's head and includes goggles 12 for protecting the eyes from being sprayed with water.

The goggles 12 comprise a pair of transparent lenses 14 carried by a frame made up of a front portion 16 that extends around the lenses 14 and that is designed to bear against the skin around the eyes so as to limit passage of water towards the eyes, and whose central portion 18 extending between the lenses 14 is a bridge designed to rest on the person's nose, and of two side branches 20 extending on either side of the person's head, at a short distance therefrom, and having rear ends 22 that are curved downwards and that are designed to be hooked over the person's ears for fastening the device 10.

An elastic strip (not shown) can also be attached between the ends 22 of the branches in order to improve the fastening of the device 10 to the person's head.

The side branches 20 of the goggles 12 form ducts for carrying water that are connected at their ends 22, via suitable flexible pipes 24, to means 26 for connecting to water feed means, such as a water supply network, diagrammatically represented by arrow 28.

The device 10 further includes water carrier ducts 30, 32 that are connected to the ducts 20 forming the side branches of the goggles 12 and that extend respectively in front of the person's forehead, and along the person's cheeks and chin and/or nose.

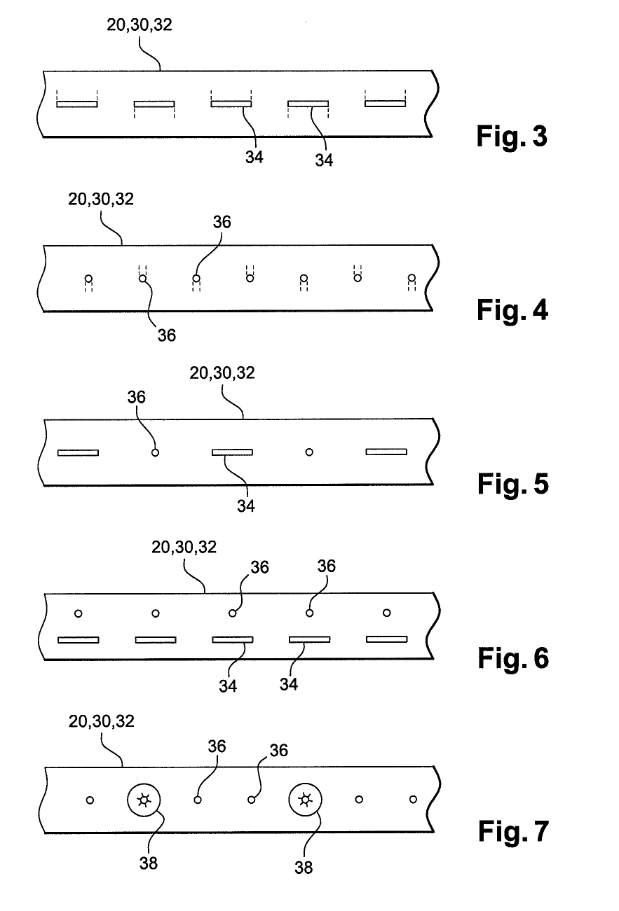

On their faces that face the skin over which they extend, the water carrier ducts 20, 30, 32 are equipped with spray nozzles for spraying water onto the skin, which nozzles are shown diagrammatically in FIGS. 3 to 7.

The ducts 20, 30, and 32 are provided with longitudinal slots 34 (FIG. 3), holes 36 (FIG. 4), or nozzles 38 (FIG. 7), or combinations thereof (FIGS. 5 to 7).

The orifices 34, 36 and the nozzles 38 are distributed regularly over a portion of the lengths of or over the entire lengths of the ducts 20, 30, 32, and are formed along one or more longitudinal lines (FIG. 6). They are designed to spray water in the form of jets, of showers, or of mist, in given directions and at a given pressure that is no greater than about 3 bars, and the nozzles 38 are preferably mounted to rotate so as to spray water in a sweeping motion, thereby increasing the area of skin treated.

In a variant, the water spray means can be distributed irregularly along the ducts 20, 30, 32.

In the embodiment shown in FIG. 1, the device 10 is designed to treat the skin of the person's forehead via the forehead bar 30, the skin of the cheeks and of the chin via the chin bar 32, and the temples via the side branches 20. The area of treated skin can be increased by using rotary nozzles 38, e.g. on the duct 30, for sprinkling water over the entire area of the forehead, and/or on the duct 32, for treating the skin situated between the mouth and the nose of the person, and/or by forming orifices 34, 36 for spraying water in predetermined directions.

In FIGS. 3 and 4, consecutive orifices 34, 36 are designed to spray water in different directions, e.g. oriented at 90° relative to each other.

The device 10 can also include means (not shown) for preventing the sprayed water from penetrating into the nose or into the ears of the person. The means for protecting the nose can, for example, extend downwards from the central portion 18 of the goggles 12.

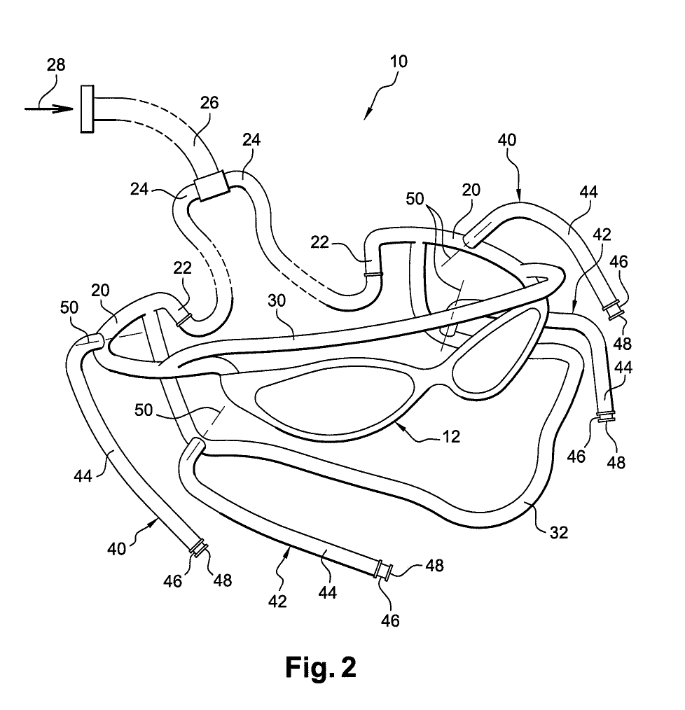

In FIG. 2, the device 10 includes additional water carrier means 40, 42 that are of adjustable length, e.g. telescopic, and that extend respectively from the side branches 20 of the goggles 12 and from the ducts 32, for cleansing and massaging a portion of the cranium and of the neck of the person.

These means 40, 42 are formed of a first duct 44, of large diameter, connected at one of its ends via suitable means to the duct 20 or 32, and of a second duct 46, that is smaller in diameter, received in leaktight manner inside the duct 44 and mounted to slide therein, its free end being provided with a stopper 48, or, for example, with a rotary nozzle (not shown).

Each of the ducts 44, 46 surround at least a portion of the cranium and of the neck of the person, and they are preferably deformable so as to match the shape(s) of said portion(s), at a small distance therefrom, and pivotable about the axes 50 in order to facilitate positioning them.

The ducts 44, 46 are also provided with orifices 34, 36 and/or with nozzles 38 for spraying water onto the cranium and onto the neck of the person.

By way of a variant, the means 40, 42 can be connected in pairs via a single duct 46, each end of which is received slidably and in leaktight manner in a duct 44.

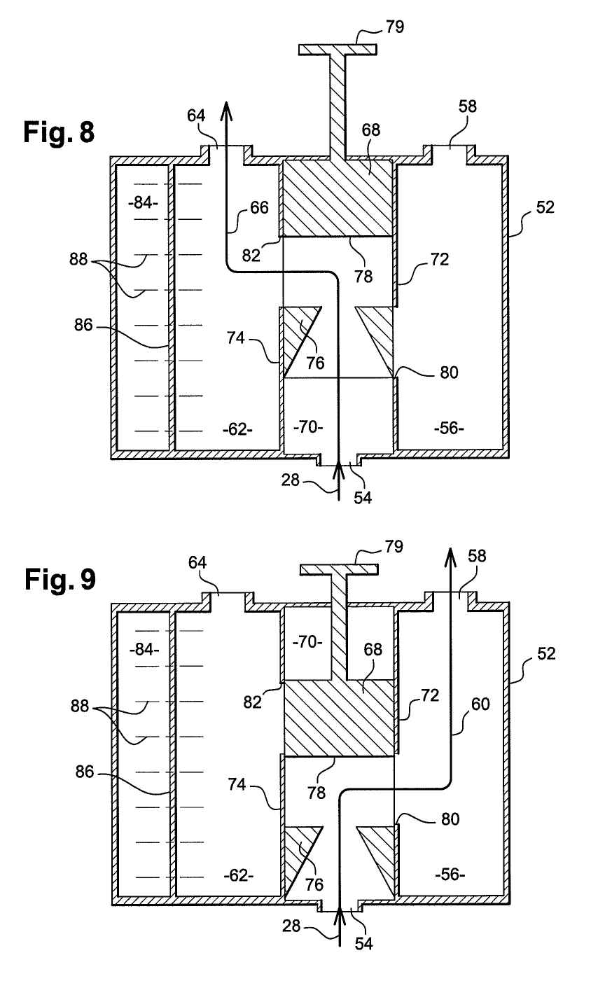

Connection means for connecting the device 10 to a water supply point 24 are shown in FIGS. 8 and 9. They comprise a housing 52 provided with a water inlet 54 designed to be connected, e.g. by screwing in an end-piece, to the orifice for receiving a shower hose that is provided on a shower or bath mixer faucet.

Said inlet 54 can be connected either to a first compartment 56 that is provided with a water outlet 58, so as to define a first water-passing channel through the housing 52, as represented diagrammatically by arrow 60 in FIG. 9, or else to a second compartment 62 that is provided with a water outlet 64, so as to define a second water-passing channel through the housing 52, as represented diagrammatically by arrow 66 in FIG. 8.

The first water-passing channel 60 or the second water-passing channel 66 through the housing 52 is selected by a body 68 being moved in a third compartment 70 that extends between the above-mentioned compartments 56, 62 and separated therefrom by respective walls 72, 74.

The body 68 is provided with an axial orifice 76 connected to the inlet 54 and to a transverse orifice 78 opening out on either side of the body 68 towards the compartments 56 and 62.

The body 68 is connected to a handle 79 for moving it in translation in the compartment 70, between a low position in which the transverse orifice 78 is aligned with an orifice 80 in the wall 72 opening out into the compartment 56 for causing water to pass as indicated arrow 60 (FIG. 9), and a high position in which the transverse orifice 78 is aligned with an orifice 82 in the wall 74 opening out into the compartment 62 for causing water to pass as indicated by arrow 66 (FIG. 8).

The housing 52 includes a fourth compartment 84 that is separated from the compartment 62 by a wall 86 that is porous or that has perforations 88 for enabling water to pass from the compartment 62 to the compartment 84 and vice versa.

The compartment 84 is designed to receive at least one active ingredient in the form of a liquid, a gel, a bead, or a tablet, etc. designed to be released by being mixed or dissolved in the water flowing from the compartment 62 to the compartment 84, and returning to the compartment 62 by passing through the wall 86.

The active ingredients used can, for example, be essential oils, plant extracts, medicines, surfactants, etc, and can have invigorating, reparative, relaxing, soothing, and other properties for the skin.

The device 10 is connected to the outlet 64 by means of the above-mentioned pipes 24 and thus makes it possible to cleanse, to massage, to relax, and to treat the skin by spraying an active ingredient having predetermined properties onto said skin. A shower hose is connected to the outlet 58.

By way of a variant, the fourth compartment 84 is separated from the compartment 62 by a wall 90 and is connected thereto via a duct 92 that opens out into the compartment 62 remote from the water outlet 64, and into the compartment 84 via an end-piece 94 that projects relative to a wall of the compartment 84.

The compartment 84 is designed to receive a cartridge 96 containing an active ingredient which, in the example shown, is inserted into the compartment 84 via an orifice 98, until the head 100 of the cartridge comes to be engaged over the end-piece 94 so as to be pierced in order to release the active ingredient into the duct 92 and into the compartment 62.

The inside diameter of the duct 92 and the viscosity of the active ingredient are determined such that the active ingredient is released in controlled manner.

The cartridge containing the active ingredient can be implemented in any form whatsoever that enables it to be fastened simply and rapidly to the housing 52, that enables the active ingredient to be released in controlled manner, and that enables said active ingredient to be mixed with the water flowing through the compartment 62.

The other compartment 56 can also be associated with a compartment such as 84 designed to receive an active ingredient packaged in suitable form, for the purpose of enabling it to be released into the water flowing through the shower hose.

The housing can also be provided with means for homogenizing the mixture of water and of active ingredient in the compartment 62 and/or in the compartment 56.

The device 10 of the invention can also include mounting means (not shown) for clipping onto hot water and cold water pipes feeding the mixer faucet.

The temperature of the water delivered by the device 10 is adjusted by means of the shower or bath mixer faucet, a low temperature being preferred for toning up the skin, and a warm temperature being preferred for improving cleansing of the skin.

In a variant, the inlet 54 of the housing can be connected to feed means for feeding gas or a liquid suitable for cleansing or treating the skin.

The device of the invention can be used on any portion of a person's body. For example, it can be designed to treat the skin:
of a calf for relieving a contracture or a cramp;
of the buttocks and of the thighs for treating cellulite;
of the back for relieving rheumatism;
of the hands for relieving arthrosis;
of the arms, of the legs, or of the torso for treating scars, e.g. burns; or
of the cranium for treating the scalp.

The device is designed to be used typically for a few minutes, or optionally for a few tens of minutes.

1. A portable device for cleansing and massaging the skin, said device comprising:
fastener means for fastening to a portion of a person's body;
connection means for connecting to fluid feed means such as a water supply network; and
fluid carrier means connected to the connection means and designed to extend around and/or along a portion of the person's body, at a short distance therefrom, said fluid carrier means being provided with orifices and/or with nozzles for spraying fluid onto said portion of the person's body.

2. A device according to claim 1, wherein the connection means comprise a housing provided with a first water-passing channel that opens out freely at the end of the housing, with a second water-passing channel for water that feeds the device, and with selector means for opening the first channel and closing the second channel or vice versa.

3. A device according to claim 1, wherein the connection means comprise ingredient-receiving means for receiving at least one active ingredient or packaging containing an active ingredient, for the purpose of releasing said active ingredient in controlled manner into the fluid that is feeding the device.

4. A device according to claim 3, wherein the active ingredient is in the form of a liquid, of a gel, of a bead, of a capsule, of a tablet, of a pellet, or of the like, and has an invigorating, reparative, relaxing, or soothing property for the skin.

5. A device according to claim 3, wherein the active ingredient is packaged in a cartridge or in a bottle, and wherein the housing includes a compartment for receiving the cartridge or the bottle, which compartment is provided with means for automatically opening the cartridge or the bottle, and with means for releasing the active ingredient in controlled manner into the water as it flows through the housing.

6. A device according to claim 1, wherein the fluid carrier means are of adjustable length, are telescopic, are deformable, and/or are hinged so as to match the shapes of the portion of the person's body, a short distance away therefrom.

7. A device according to claim 1, wherein the fluid carrier means comprise at least one duct equipped with fluid spray means over at least a portion of its length.

8. A device according to claim 7, wherein the fluid spray means comprise at least one rotary nozzle for spraying fluid in a sweeping motion.

9. A device according to claim 1, the device being designed to be fastened to a person's head and includes eye-protection goggles whose side branches form fluid carrier ducts.

10. A device according to claim 9, wherein fluid carrier ducts forming a chin bar and/or a forehead bar, are connected to the ducts forming the side branches of the goggles.

11. A device according to claim 9, including fluid carrier ducts equipped with fluid spray means and connected to the side branches of the goggles, and designed to surround at least a portion of the cranium and/or of the neck of the person.

12. A device according to claim 1, wherein the sprayed fluid comprises water in vapor or liquid form.

13. A device according to claim 1, the device being designed to be connected to the shower hose receiving orifice provided on a shower or bath mixer faucet.

14. A device according to claim 1, the device being provided with mounting means for mounting by being clipped onto hot water and cold water pipes of a shower or bath mixer faucet.
